(19) United States
(12) Patent Application Publication
(10) Pub. No.: US 2026/0333382 A1
(43) Pub. Date: Oct. 22, 2026

(54) SLOT FORMAT CONFIGURATION FOR DISCONTINUOUS TRANSMISSION AND DISCONTINUOUS RECEPTION

(71) Applicant: Lenovo (United States) Inc., Morrisville, NC (US)

(72) Inventors: Karthikeyan Ganesan, Nauheim (DE); Khaled Nafez Rauf Ardah, Ilmenau (DE)

(73) Assignee: Lenovo (United States) Inc., Morrisville, NC (US)

(21) Appl. No.: 19/413,262

(22) Filed: Dec. 9, 2025

(51) Int. Cl. H04W 72/232; H04W 72/0446; H04W 76/28

(52) U.S. Cl. CPC H04W 72/232; H04W 72/0446; H04W 76/28

(57) ABSTRACT

Various aspects of the present disclosure relate to slot format configuration for discontinuous transmission (DTX) and/or discontinuous reception (DRX). A user equipment (UE) receives first signaling that indicates a set of slot formats associated with a DTX cycle and a DRX cycle corresponding to a network equipment (NE). The set of slot formats includes a first slot format associated with an ON duration of at least one of the DTX cycle or the DRX cycle and a second slot format associated with an OFF duration of the at least one of the DTX cycle or the DRX cycle. The UE communicates second signaling based on the ON duration of the at least one of the DTX cycle or the DRX cycle and using the first slot format and the second slot format.

### TECHNICAL FIELD

The present disclosure relates to wireless communications, and more specifically to configuring resources for wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive first signaling that indicates a set of slot formats (e.g., a plurality, multiple) associated with a discontinuous transmission (DTX) cycle and a discontinuous reception (DRX) cycle corresponding to an NE, where the set of slot formats includes a first slot format associated with an ON duration (e.g., active duration or period, on duration or period) of at least one of the DTX cycle or the DRX cycle and a second slot format associated with an OFF duration (e.g., inactive duration or period, non-active duration or period, off duration or period) of the at least one of the DTX cycle or the DRX cycle, and communicate, based on the ON duration of the at least one of the DTX cycle or the DRX cycle, second signaling based on the first slot format and the second slot format.

A processor (e.g., a standalone processor chipset, or a component of a UE) for wireless communication is described. The processor may be configured to, capable of, or operable to perform one or more operations as described herein. For example, the processor may be configured to, capable of, or operable to receive first signaling that indicates a set of slot formats associated with a DTX cycle and a DRX cycle corresponding to an NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format.

A method performed or performable by a UE for wireless communication is described. The method may include receiving first signaling that indicates a set of slot formats associated with a DTX cycle and a DRX cycle corresponding to an NE, where the set of slot formats includes a first slot format associated with an ON duration of at least one of the DTX cycle or the DRX cycle and a second slot format associated with an OFF duration of the at least one of the DTX cycle or the DRX cycle, and communicating, based on the ON duration of the at least one of the DTX cycle or the DRX cycle, second signaling based on the first slot format and the second slot format.

In some implementations of the UE, the processor, and the method described herein, the UE, the processor, and the method may further be configured to, capable of, or operable to receive one or more downlink control information (DCI) that indicate the first slot format and the second slot format, where the first signaling includes the one or more DCI. In some implementations, the one or more DCI include a dedicated DCI received during the ON duration of the DTX cycle and a common DCI received prior to an ON duration of the DTX cycle or an ON duration of the DRX cycle. In some implementations, the UE, the processor, and the method may further be configured to, capable of, or operable to receive radio resource control (RRC) signaling including respective sets of slot formats associated with a set of DTX cycles and DRX cycles, where the respective sets of slot formats include the set of slot formats. In some implementations, the RRC signaling is received prior to the first signaling, and the first signaling includes at least one DCI that activates the first slot format and the second slot format. In some implementations, the first signaling includes the RRC signaling, and the UE, the processor, and the method may further be configured to, capable of, or operable to apply, based on the DTX cycle and the DRX cycle, at least one of the first slot format or the second slot format for one or more durations associated with the second signaling.

In some implementations, to communicate the second signaling, the UE, the processor, and the method may further be configured to, capable of, or operable to at least one of receive, during an ON duration of the DTX cycle, the second signaling based on the first slot format, transmit, during an ON duration of the DRX cycle, the second signaling based on the first slot format, receive, during an OFF duration of the DRX cycle, the second signaling based on the second slot format, or transmit, during an OFF duration of the DTX cycle, the second signaling based on the second slot format. In some implementations, the UE, the processor, and the method may further be configured to, capable of, or operable to apply the second slot format for a first duration corresponding to an OFF duration of the DTX cycle and an ON duration of the DRX cycle, where the ON duration of the DRX cycle overlaps with the OFF duration of the DTX cycle, and apply, after the first duration, the first slot format for a second duration corresponding to an ON duration of the DTX cycle and the ON duration of the DRX cycle. In some implementations, the UE, the processor, and the method may further be configured to, capable of, or operable to apply the second slot format to one or more slots associated with an ON duration of a DTX cycle, where the one or more slots include uplink slots. In some implementations, the UE, the processor, and the method may further be configured to, capable of, or operable to apply at least one of the first slot format or the second slot format a threshold duration after receiving the first signaling, where the threshold duration is based on a current ON duration of at least one of the DTX cycle or the DRX cycle or a subsequent ON duration of at least one of the DTX cycle or the DRX cycle.

An NE (e.g., a base station, network entity) for wireless communication is described. The NE may be configured to, capable of, or operable to perform one or more operations as described herein. For example, the NE may be configured to, capable of, or operable to transmit first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format.

A method performed or performable by an NE (e.g., a base station) for wireless communication is described. The method may include transmitting first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle, and communicating, based on the ON duration of the at least one of the DTX cycle or the DRX cycle, second signaling based on the first slot format and the second slot format.

In some implementations of the NE, the processor, and the method described herein, the NE, the processor, and the method may further be configured to, capable of, or operable to transmit one or more DCI that indicate the first slot format and the second slot format, where the first signaling includes the one or more DCI. In some implementations, the one or more DCI include a dedicated DCI received during the ON duration of the DTX cycle and a common DCI received prior to an ON duration of the DTX cycle or an ON duration of the DRX cycle. In some implementations, the NE, the processor, and the method may further be configured to, capable of, or operable to transmit RRC signaling including respective sets of slot formats associated with a set of DTX cycles and DRX cycles, where the respective sets of slot formats include the set of slot formats. In some implementations, the RRC signaling is transmitted prior to the first signaling, and the first signaling includes at least one DCI that activates the first slot format and the second slot format. In some implementations, the first signaling includes the RRC signaling, and the NE, the processor, and the method may further be configured to, capable of, or operable to apply, based on the DTX cycle and the DRX cycle, at least one of the first slot format or the second slot format for one or more durations associated with the second signaling.

In some implementations, to communicate the second signaling, the NE, the processor, and the method may further be configured to, capable of, or operable to at least one of transmit, during an ON duration of the DTX cycle, the second signaling based on the first slot format, receive, during an ON duration of the DRX cycle, the second signaling based on the first slot format, transmit, during an OFF duration of the DRX cycle, the second signaling based on the second slot format, or receive, during an OFF duration of the DTX cycle, the second signaling based on the second slot format. In some implementations, the NE, the processor, and the method may further be configured to, capable of, or operable to apply the second slot format for a first duration corresponding to an OFF duration of the DTX cycle and an ON duration of the DRX cycle, where the ON duration of the DRX cycle overlaps with the OFF duration of the DTX cycle, and apply, after the first duration, the first slot format for a second duration corresponding to an ON duration of the DTX cycle and the ON duration of the DRX cycle. In some implementations, the NE, the processor, and the method may further be configured to, capable of, or operable to apply the second slot format to one or more slots associated with an ON duration of a DTX cycle, where the one or more slots include uplink slots. In some implementations, the NE, the processor, and the method may further be configured to, capable of, or operable to apply at least one of the first slot format or the second slot format a threshold duration after transmitting the first signaling, where the threshold duration is based on a current ON duration of at least one of the DTX cycle or the DRX cycle or a subsequent ON duration of at least one of the DTX cycle or the DRX cycle.

### BRIEF DESCRIPTION OF THE DRAWINGS

FIG. 1 illustrates an example of a wireless communications system in accordance with aspects of the present disclosure.

FIGS. 2 through 4 illustrate examples of transmission diagrams, in accordance with aspects of the present disclosure.

FIG. 5 illustrates an example of a signaling diagram, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a UE and an NE (e.g., a base station, a gNB) may support transmission and reception of signaling, referred to as wireless communication. The NE and the UE may transmit and receive the signaling in one or more time and frequency resources. The time resources may include one or more slots, where a slot is a unit in the time domain, and the slots may be split into smaller units, referred to as symbols. In some cases, the NE and the UE may implement a slot format that defines a structure for transmission and reception within a slot, where the slot format may indicate which symbols within the slot are designated (e.g., assigned, allocated, scheduled) for uplink transmission, downlink transmission, or flexible use (e.g., uplink, downlink, or other use). The NE may signal (e.g., indicate) the slot format to the UE, and both the NE and the UE may configure transmission and reception of signaling according to the slot format.

In some cases, the UE and the NE may also implement a pattern (e.g., schedule, configuration) for transmission and/or reception to conserve power resources, such as discontinuous transmission (DTX) cycles and/or discontinuous reception (DRX) cycles. For example, the UE and/or the NE may transmit during one or more ON durations (e.g., active durations or periods, on durations or periods) of a DTX cycle and may refrain from transmitting (e.g., skip transmission) during one or more OFF durations (e.g., inactive durations or periods, non-active durations or periods, off durations or periods) of the DTX cycle. Additionally, or alternatively, the UE and/or the NE may receive during one or more ON durations of a DRX cycle and may not monitor (e.g., skip monitoring, listening, detecting) for transmission reception during one or more OFF durations of the DRX cycle. An NE may reduce power consumption by periodically suspending (e.g., muting or deactivating) transmission and reception according to the DTX cycle and the DRX cycle, respectively, such as when there are less than a threshold numerical quantity of UEs served by the NE. In some cases, the slot format may be configured independently of a DTX cycle and/or a DRX cycle, which may result in inefficiencies in power conservation and resource utilization. For example, if a slot format remains unchanged between active and inactive periods of the DTX cycle and/or the DRX cycle, then the NE may wait for available uplink or downlink slots according to the configured slot format before transmitting or receiving signaling, even during ON durations of a DTX cycle or a DRX cycle, respectively.

As described herein, to improve resource allocation and power efficiency, an NE may transmit signaling to a UE that indicates slot formats for coordinating with DTX cycles and/or DRX cycles at the NE. For example, the NE may transmit signaling, including RRC signaling or other control signaling, to a UE that configures a set of slot formats. The slot formats may include one or more slot formats for use during ON durations of the DTX cycle and/or DRX cycle and one or more additional slot formats for use during OFF durations of the DTX cycle and/or DRX cycle. The NE may transmit additional signaling, such as a DCI or other control signaling, that activates slot formats from the configured slot formats and that also indicates a DTX cycle and/or DRX cycle that the NE implements. The UE uses the activated slot formats and timing information from the DTX cycle and/or the DRX cycle to coordinate transmissions and receptions during ON and OFF durations. For example, during ON durations of the DTX cycle, the UE may apply a slot format that includes more downlink symbols to facilitate increased downlink transmission from the NE, and during OFF durations of the DTX cycle, the UE may apply a different slot format that includes more uplink symbols or flexible symbols to enable uplink transmission or other communication patterns. Additionally, or alternatively, during ON durations of the DRX cycle, the UE may apply a slot format that includes more uplink symbols to facilitate increased uplink transmission to the NE, and during OFF durations of the DRX cycle, the UE may apply a different slot format that includes more downlink symbols or flexible symbols to enable downlink reception or other communication patterns. In some cases, the NE may configure different slot formats for overlapping or non-overlapping periods of DTX and DRX cycles, such as applying a slot format with more flexible symbols during periods when the DTX cycle is OFF and the DRX cycle is ON, or applying a slot format with more downlink and uplink symbols during periods when both the DTX cycle and the DRX cycle are ON.

By performing the described techniques, a device (e.g., a UE and/or an NE) in a wireless communications system may provide for improved resource allocation, power efficiency, and communication performance during DTX and DRX operation. For example, an NE may configure a UE with slot format configurations that align with DTX and DRX cycles of the NE, enabling the UE to adapt transmission and reception patterns based on whether the NE is in an ON duration or an OFF duration of the DTX cycle or the DRX cycle. The UE may achieve improved resource utilization through coordinated slot format selection, where the slot format applied during ON durations of the DTX cycle or the DRX cycle includes more symbols designated for active transmission or reception, while the slot format applied during OFF durations includes more flexible symbols or symbols designated for the opposite direction of communication. The coordination may reduce latency and improve throughput by ensuring that uplink and downlink resources are available when the NE is actively transmitting or receiving, while also conserving power during OFF durations by reducing unnecessary monitoring or transmission attempts. Additionally, the NE may reduce power consumption by applying slot formats that minimize transmission and reception activity during OFF durations, while maintaining communication capability through flexible symbol allocation.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

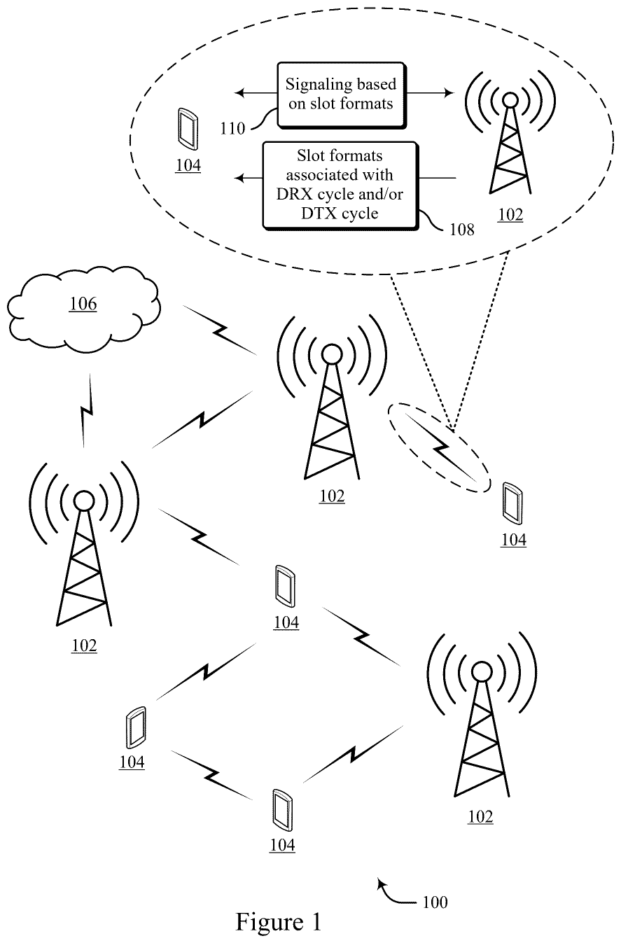

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station (STA), a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some cases, an NE 102 and/or a UE 104 may implement a DRX cycle and/or a DTX cycle with active periods (e.g., ON durations or periods) and non-active periods (e.g., OFF durations or periods, inactive or non-active durations or periods). For example, the NE 102 implements the DRX cycle and/or the DTX cycle for time domain network energy saving (NES) that provides for an NE 102 (e.g., a base station, a gNB) to reduce power consumption by periodically suspending transmission and/or reception activities, for example if an active number of users (e.g., UEs 104) is less than or equal to a threshold value. A DTX cycle for an NE 102 defines one or more periods when the NE 102 refrains from transmitting signals, including downlink data transmissions and reference signals. A DRX cycle for an NE 102 defines one or more periods when the NE 102 does not monitor for or receive uplink transmissions from UEs 104. Each DTX cycle and DRX cycle includes an ON duration (e.g., on duration or period, active duration or period) during which the NE 102 performs transmission or reception activities, and an OFF duration (e.g., off duration or period, inactive duration or period, non-active duration or period) during which the NE 102 suspends the respective transmission or reception activities.

In some examples, the NE 102 may support one or more DTX cycles and/or DRX cycles (e.g., referred to as cell DTX cycles, cell DRX cycles, DTX cycles for an NE 102, and/or DRX cycles for an NE 102) to reduce power consumption during periods of reduced or low activity. A cell, which represents the coverage area served by an NE 102, operates according to the DTX and DRX configurations established by the NE 102. The NE 102 may preconfigure or define multiple DTX and DRX cycle configurations for a cell or for a carrier to accommodate different operational scenarios and traffic patterns. A carrier may refer to a frequency within a frequency band, where an NE 102 and/or a UE 104 may use the carrier to exchange (e.g., transmit, receive, communicate) information. The DTX and DRX cycle configurations implemented by the NE 102 serve as time domain NES mechanisms that provide for the NE 102 to reduce a power consumption by periodically muting or deactivating transmission and/or reception activities, such as when there are no or minimum active UEs 104 (e.g., less than a threshold numerical quantity, number, or amount of active UEs 104). In some cases, the DTX cycles and DRX cycles (e.g., active time periods and non-active time periods of the DTX cycles and DRX cycles) may be separately configured or jointly configured for transmission and reception. For a separate configuration, the NE 102 may configure independent DTX and DRX cycles with different periodicities and timing parameters, enabling the NE 102 to independently control transmission and reception activities. For a joint configuration, the NE 102 may configure coordinated DTX and DRX cycles with synchronized timing parameters, such as both cycles having a same periodicity and aligned ON durations, providing for coordinated power saving across both transmission and reception activities.

In some examples, an NE 102 may configure a cell or carrier with one or more DTX cycle and/or DRX cycle configurations that define different operational states. The DTX cycle and/or DRX cycle configurations may include cell active transmission and reception periods, where both downlink and uplink activities occur simultaneously. Additionally, or alternatively, the DTX cycle and/or DRX cycle configurations may include cell active reception periods, where the NE 102 monitors for uplink transmissions but refrains from downlink transmissions. Additionally, or alternatively, the DTX cycle and/or DRX cycle configurations may include cell active transmission periods, where the NE 102 transmits downlink signals but does not monitor for uplink transmissions. Additionally, or alternatively, the DTX cycle and/or DRX cycle configurations may include cell non-active transmission and reception periods, where both transmission and reception activities are suspended. The cell active transmission periods may be referred to as ON durations of a DTX cycle, and the cell active reception periods may be referred to as ON durations of a DRX cycle. The non-active periods may be referred to as OFF durations of the respective DTX or DRX cycles. One or more configuration parameters define the DTX and/or DRX cycles, including one or more starting time parameters that indicate when a DTX and/or a DRX cycle begins, one or more slot offset parameters that indicate a delay from a reference point, one or more on-duration parameters that indicate how long the active period lasts, and/or one or more periodicity parameters that indicate how frequently the cycles repeat.

In some examples, an NE 102 may communicate with one or more UEs 104 according to the DTX cycle and/or the DRX cycle by coordinating transmission and reception activities to align with ON durations of the respective cycles. During ON durations of the DTX cycle, the NE 102 may transmit downlink signals, including control information, data, and/or reference signals, to the UEs 104. During ON durations of the DRX cycle, the NE 102 may monitor for and receive uplink transmissions from the UEs 104, including uplink data, control information, and/or reference signals. The NE 102 may indicate the DTX and DRX cycles that the NE 102 is using to the UEs 104 to enable the UEs 104 to coordinate transmission and reception activities. The NE 102 may transmit signaling that indicates the DTX and DRX cycle configurations, including the configuration parameters (e.g., starting time, slot offset, ON duration time, and/or periodicity). In some cases, the NE 102 may transmit control signaling, such as RRC signaling, to one or more UEs 104 that indicates a list of one or more DTX cycle and/or DRX cycle configurations.

The control signaling may include one or more parameters (e.g., fields, indicators) of respective DTX cycles and/or DRX cycles. For example, the control signaling may be or include a CellDTX-DRX-Config information element (IE) that configures cell DTX and/or DRX related parameters. The parameters may include, but are not limited to, a starting time indicating when a DTX and/or DRX cycle begins in a time domain, a slot offset that indicates a delay from a reference point, an ON duration time that indicates how long an active period lasts, a periodicity that indicates how frequently the DTX cycle and/or DRX cycle repeats, a cellDTX-DRX-CycleStartOffset that indicates the starting offset for a cell DTX-DRX-Cycle as an integer multiple of configured drx-Cycle or vice versa, a cellDTX-DRX-Cycle that indicates the cell DTX-DRX cycle duration in milliseconds, a cellDTX-DRX-StartOffset that indicates when a UE 104 is to start monitoring for cell DTX-DRX-Cycle activation signaling, a cellDTX-DRX-ActivationStatus that indicates an initial activation status of cell DTX and/or DRX), cellDTX-DRX-ConfigType that indicates whether the configuration is for cell DTX, cell DRX, or joint cell DTX and DRX configuration, a cellDTX-DRX-ActiveTime that indicates an active duration with enumerated values ranging from 0 to 31, and/or a positionInDCI-cellDTRX that indicates a starting position of a block associated with a serving cell in DCI format 2_9.

The NE 102 may transmit additional control signaling to at least one of the UEs 104 (e.g., UE-group common DCI 2_9 or other control signaling) that activates or deactivates a DTX and/or a DRX cycle configuration from the indicated DTX cycle and/or DRX cycle configurations. The additional control signaling may indicate which of the DTX cycle and/or DRX cycle configurations is currently active, enabling the UEs 104 to determine when the NE 102 is transmitting downlink transmissions and when the NE 102 is monitoring for uplink transmissions. The DCI format 2_9 is used for activating or deactivating cell DTX cycle and/or DRX cycle configurations for one or more serving cells across one or more UEs 104, and for providing an NES-mode indication of a primary cell. The DCI format 2_9 is transmitted with cyclic redundance check (CRC) bits scrambled by a radio network temporary identifier (RNTI) (e.g., cellDTRX-RNTI) and includes block configurations, where each block is associated with a serving cell. The starting position of a block associated with a serving cell (e.g., block number 1, block number 2, . . . , block number N) is determined by the parameter positionInDCI-cellDTRX provided by higher layers for the UE 104. Each block includes a cell DTX and/or DRX indication field with a number of bits. For example, if a higher layer parameter cellDTX-DRX-L1activation is configured, then the number of bits is two bits if cellDTX-DRX-ConfigType is configured to DTXDRX for the associated serving cell, with the most significant bit (MSB) corresponding to cell DTX configuration and the least significant bit (LSB) corresponding to cell DRX configuration. Additionally, or alternatively, if a higher layer parameter cellDTX-DRX-L1activation is configured, then the number of bits is one bit if cellDTX-DRX-ConfigType is configured to either DTX or DRX for the associated serving cell. Otherwise, the number of bits is zero. Each block may include a NES-mode indication field of one bit indicating an NES conditional handover (CHO) execution condition if a higher layer parameter nesEvent is configured and an associated serving cell is a primary cell, or 0 bits otherwise. The size of DCI format 2_9 is indicated by the higher layer parameter sizeDCI-2-9.

In the wireless communications system 100, the NEs 102 and the UEs 104 may communicate using one or more communication resources, including resources in the time domain (e.g., symbols, slots, subframes, frames, or the like) and/or resources in the frequency domain (e.g., subcarriers, carriers, or the like). A slot may refer to a time domain unit used for transmission and reception of wireless signals, where each slot includes a set of symbols (e.g., OFDM symbols) that carry data, control information, and/or reference signals. The duration and structure of a slot may depend on a numerology (e.g., subcarrier spacing) configured for the wireless communications system 100, with different numerologies supporting different numbers of slots per subframe and different numbers of symbols per slot. In some examples, the NE 102 and the UE 104 may implement slot formats that define a structure for transmission and reception within a slot. A slot format indicates which symbols within the slot are designated for uplink transmission, downlink transmission, or flexible use (e.g., symbols that can be dynamically allocated for either uplink or downlink transmission). An NE 102 may configure slot formats independently of DTX cycles and/or DRX cycles. For example, the NE 102 may configure a slot format at one or more UEs 104 via control signaling, such as a DCI format 2_0. The DCI format 2_0 is used for indicating the slot format, a channel occupancy time (COT) duration, one or more available resource block (RB) sets, and/or search space set group switching. The DCI format 2_0 is transmitted with CRC bits scrambled by a slot format indicator (SFI)-RNTI and includes multiple slot format indicators, available RB set indicators, COT duration indicators, and/or search space set group switching flags. The size of DCI format 2_0 is configurable by higher layers (e.g., up to 128 bits). However, configuring slot formats independently of cell DTX and DRX cycles may result in inefficient resource utilization and reduced power savings.

For example, some signals may be transmitted even during cell non-active time periods, which may reduce power saving efficiency. To improve coordination and power saving efficiency, an NE 102 and a UE 104 may implement aligned DTX and DRX cycles. However, in some cases, the DTX cycle and DRX cycle configurations may be independent of slot format configurations, which may result in inefficiencies in resource utilization and power conservation. For example, if a slot format remains unchanged between active and inactive periods of a DTX cycle and/or the DRX cycle of and NE 102, then the NE 102 may wait for available uplink or downlink slots according to the configured slot format before transmitting or receiving signaling, even during ON durations of a DTX cycle or a DRX cycle, respectively. In some cases, the availability of one or more defined slot types may impact energy savings, such as by enabling early channel state information (CSI) triggering and improving system efficiency.

According to implementations, one or more of the NEs 102 and the UEs 104 are operable to implement various aspects of the techniques described with reference to the present disclosure. In some examples, an NE 102 and a UE 104 may implement flexible slot format configurations that account for DTX and DRX cycles. The NE 102 may configure a UE 104 with multiple slot formats associated with a DRX cycle and/or a DTX cycle 108, where a first slot format applies during cell active transmission and/or reception periods and a second slot format applies during at least one of cell non-active transmission or reception periods. For example, the UE 104 and the NE 102 may apply a slot format that includes both downlink and uplink symbols during an ON duration of a DTX cycle and a DRX cycle of the NE 102 that overlap in a time domain. In some other examples, the UE 104 and the NE 102 may apply a slot format that includes downlink symbols during an ON duration of a DTX cycle of the NE 102 that overlaps with an OFF duration of a DRX cycle of the NE 102. In some other examples, the UE 104 and the NE 102 may apply a slot format that includes uplink symbols during an ON duration of a DRX cycle of the NE 102 that overlaps with an OFF duration of a DTX cycle of the NE 102. A slot format is associated with a DTX and/or DRX cycle state when the slot format is configured to be applied during that state, such as during an ON duration or an OFF duration of the DTX and/or DRX cycle. The NE 102 may signal one or more slot formats and DTX cycle and DRX cycle configurations semi-statically (e.g., via RRC signaling). Additionally, or alternatively, the NE 102 may transmit dynamic signaling (e.g., via one or more DCI) to activate a DTX and/or DRX cycle configuration and corresponding slot format. The NE 102 and the UE 104 may exchange signaling (e.g., transmit and/or receive control signaling, data, and/or reference signals), such as the signaling based on the slot formats 110.

As used herein, the term “ON duration” (e.g., also referred to as “on duration,” “active duration,” or “active period”) refers to a time period during which a device (e.g., a UE 104 or an NE 102) actively transmits or receives signals according to a DTX cycle or a DRX cycle. For example, during an ON duration of a DTX cycle, a device may actively transmit downlink or uplink signals, and during an ON duration of a DRX cycle, a device may actively monitor for and receive transmissions. The term “OFF duration” (also referred to as “off duration,” “inactive duration,” “non-active duration,” or “non-active period”) refers to a time period during which a device refrains from transmitting (e.g., in a DTX cycle) or monitoring for reception (e.g., in a DRX cycle) to conserve power. During OFF durations, transmission and/or reception activities may be muted, deactivated, or suspended.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

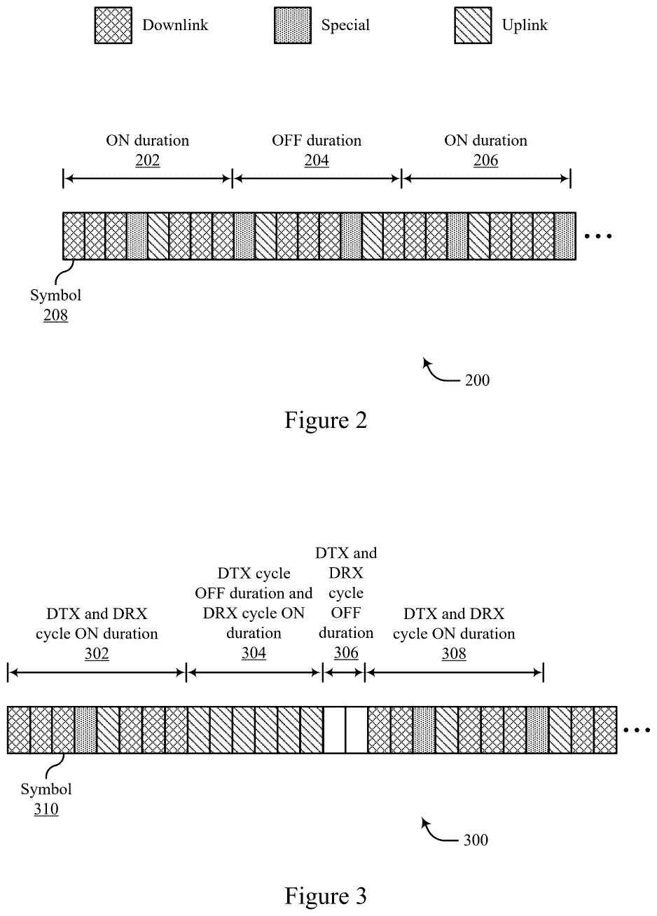

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 may be implemented by one or more UEs and/or NEs, which may be an example of NEs 102 and UEs 104 as described with reference to FIG. 1. The transmission diagram 200 illustrates an example of a slot format relative to a DTX cycle or a DRX cycle implemented by an NE.

In some examples, an NE may implement both slot format configurations and DTX and/or DRX cycles to manage transmission and reception to and from one or more UEs across time domain resources. For example, the NE may configure slot formats that define symbol-level resource allocation within slots, while separately or jointly configuring DTX cycles that control transmission periods and DRX cycles that control reception monitoring periods. A DRX cycle and/or a DTX cycle may have an ON duration 202, an OFF duration 204, and an ON duration 206. In some cases, the ON durations may repeat in the time domain according to a periodicity, such that the ON duration 202 and the ON duration 206 may be the same. In some other cases, the ON durations may not repeat in the time domain and/or may vary in the time domain according to a periodicity, such that the ON duration 202 and the ON duration 206 may be different values. In some examples, the OFF duration 204 may also repeat in the time domain according to a periodicity (e.g., a same periodicity as the ON duration 202 and/or the ON duration 206 or a different periodicity). In some other examples, the OFF duration 204 may not repeat in the time domain. The OFF duration 204 may have a same value as the ON duration 202 and/or the ON duration 206, or may have a different value. An NE can transmit signaling to a UE that indicates parameters of the DRX cycle and/or the DTX cycle, such as parameters that define the ON duration 202, the OFF duration 204, and the ON duration 206 (e.g., a starting time parameter, a slot offset parameter, an ON duration parameter, and/or a periodicity parameter, among other examples). The ON duration 202, the OFF duration 204, and/or the ON duration 206 may be part of a DTX cycle and/or a DRX cycle.

The ON duration 202 represents a first time period during which an NE operates in an active state (e.g., active duration or period, on duration or period). The OFF duration 204 represents a second time period during which the NE operates in an inactive state (e.g., inactive duration or period, non-active duration or period, off duration or period). The ON duration 206 represents a third time period during which the DTX cycle or the DRX cycle returns to an active state. The ON duration 202, the OFF duration 204, and the ON duration 206 may span one or more symbols 208, where the NE designates each of the symbols 208 for uplink transmission, downlink transmission, or special use according to a configured slot format. The NE may allocate special symbols for uplink or downlink transmission or for other purposes, such as guard periods for transitioning between uplink and downlink.

In some cases, the NE configures slot formats independently of DTX and DRX cycles. For example, the slot format may remain unchanged across the ON duration 202, the OFF duration 204, and the ON duration 206, regardless of whether the NE actively transmits or receives. During the ON duration 202 and the ON duration 206, the NE may actively transmit downlink signals (e.g., in a DTX cycle) or actively monitor for uplink transmissions (e.g., in a DRX cycle). However, the static slot format configuration may not provide sufficient downlink or uplink resources during the active periods, causing the NE to wait for available slots according to the configured slot format before the NE transmits or receives signaling. During the OFF duration 204, the NE may refrain from transmitting (e.g., in a DTX cycle) or may not monitor for uplink transmissions (e.g., in a DRX cycle), yet the slot format may still allocate resources for transmission or reception that the NE does not utilize, resulting in inefficient resource allocation. In some cases, the availability of one or more slot types during active periods may impact energy savings and network efficiency, such as by affecting the timing of CSI triggering or scheduling opportunities.

To improve resource allocation, efficiency, and energy savings, an NE may coordinate slot format configurations with DTX and DRX cycles. An NE may configure multiple slot formats that the NE associates with different states of the DTX and DRX cycles, where the NE applies a first slot format during ON durations (e.g., active durations or periods, on durations or periods) of the DTX cycle and/or the DRX cycle, and the NE applies a second slot format during OFF durations (e.g., inactive durations or periods, non-active durations or periods, off durations or periods) of the DTX cycle and/or the DRX cycle. The first slot format may include a higher proportion of downlink symbols during ON durations of a DTX cycle to facilitate increased downlink transmission from the NE, or may include a higher proportion of uplink symbols during ON durations of a DRX cycle to facilitate increased uplink transmission to the NE. The second slot format may include a higher proportion of uplink symbols, downlink symbols, or special symbols during OFF durations to enable alternative communication patterns or to reduce unnecessary resource allocation. By coordinating slot format selection with DTX and DRX cycle timing, the NE and the UE may achieve improved resource utilization, reduced latency during active periods, and enhanced power conservation during inactive periods.

FIG. 3 illustrates an example of a transmission diagram 300 in accordance with aspects of the present disclosure. In some examples, the transmission diagram 300 implements or is implemented by aspects of the wireless communications system 100 and/or the transmission diagram 200. For example, the transmission diagram 300 may be implemented by one or more UEs and/or NEs, which may be an example of NEs 102 and UEs 104 as described with reference to FIG. 1. The transmission diagram 300 illustrates an example of aligning slot formats with a DTX cycle and/or a DRX cycle.

In some examples, an NE configure multiple slot formats that align with DTX and/or DRX cycles for transmission and reception to and from one or more UEs across time domain resources. For example, the NE may configure slot formats that define symbol-level resource allocation within slots, while separately or jointly configuring DTX cycles that control transmission periods and DRX cycles that control reception monitoring periods. A DRX cycle and a DTX cycle may align, such that an ON duration at least partially overlaps in the time domain for both the DRX cycle and the DTX cycle. The ON duration may be referred to as a DTX and DRX cycle ON duration 302. The DTX cycle may have an OFF duration that at least partially overlaps in the time domain with a DRX cycle ON duration, which is referred to as a DTX cycle OFF duration and DRX cycle ON duration 304. An OFF duration of a DTX cycle may at least partially overlap in the time domain with an OFF duration of a DRX cycle, which is referred to as a DTX and DRX cycle OFF duration 306.

In some cases, the ON durations and/or the OFF durations of the DTX and DRX cycles may repeat in the time domain according to a periodicity, such that the DTX and DRX cycle ON duration 302 and a DTX and DRX cycle ON duration 308 may be the same. In some other cases, the ON durations and/or the OFF durations of the DTX and DRX cycles may not repeat in the time domain and/or may vary in the time domain according to a periodicity, such that the DTX and DRX cycle ON duration 302 and the DTX and DRX cycle ON duration 308 may be different values. The periodicity may be configured based on traffic patterns, quality of service criterion, or network load conditions. An NE can transmit signaling to a UE that indicates parameters of the DRX cycle and/or the DTX cycle, such as parameters that define the DTX and DRX cycle ON duration 302, the DTX cycle OFF duration and DRX cycle ON duration 304, the DTX and DRX cycle OFF duration 306, and the DTX and DRX cycle ON duration 308 (e.g., a starting time parameter, a slot offset parameter, an ON duration parameter, and/or a periodicity parameter, among other examples). The signaling may be transmitted via RRC signaling for semi-static configuration or via DCI for dynamic activation and deactivation of one or more defined DTX and DRX cycle configurations.

The DTX and DRX cycle ON duration 302 represents a first time period during which both the DTX cycle and the DRX cycle are in an ON state, where the NE operates in an active transmission and reception state. During this period, the NE can transmit downlink signals including control information, data, and reference signals, while simultaneously monitoring for uplink transmissions from UEs. The DTX cycle OFF duration and DRX cycle ON duration 304 represents a second time period during which the DTX cycle is in an OFF state while the DRX cycle remains in an ON state, where the NE refrains from transmission but continues to monitor for reception. The NE may receive uplink transmissions while conserving power by not transmitting downlink signals. The DTX and DRX cycle OFF duration 306 represents a third time period during which both the DTX cycle and the DRX cycle are in an OFF state, where the NE operates in an inactive transmission and reception state. During the DTX and DRX cycle OFF duration 306, the NE may enter a deep sleep mode to improve power savings. A deep sleep mode refers to a low power state in which a device (e.g., an NE or a UE) reduces or minimizes power consumption by deactivating or suspending one or more functional components, including transmission and reception circuitry, processing units, or monitoring functions. In the deep sleep mode, the device may maintain minimal functionality to enable periodic wake up or to respond to wake up signals (WUSs), while conserving energy during periods of inactivity. The DTX and DRX cycle ON duration 308 represents a fourth time period during which both the DTX cycle and the DRX cycle return to an ON state. The DTX and DRX cycle ON duration 302, the DTX cycle OFF duration and DRX cycle ON duration 304, the DTX and DRX cycle OFF duration 306, and the DTX and DRX cycle ON duration 308 may span one or more symbols 310, where the NE designates each of the symbols 310 for uplink transmission, downlink transmission, or special use according to a configured slot format, as described with reference to FIG. 2.

The NE may configure a cell or a carrier with one or more cell DTX and DRX cycle configurations, including but not limited to, cell active transmission and reception periods, cell active reception periods, cell active transmission periods, and/or cell non-active transmission and reception periods. Each configuration type serves different operational scenarios. For example, cell active transmission and reception periods enable full duplex communication, cell active reception periods enable uplink monitoring while conserving transmission power, cell active transmission periods enable downlink transmission without uplink monitoring, and cell non-active transmission and reception periods provide maximum power savings by enabling the NE to enter a sleep mode. In some cases, the NE associates slot formats to different DTX and DRX cycle configurations (e.g., DTX and DRX cycle ON duration and OFF duration combinations). For example, the NE associates (e.g., determines, identifies, selects) a slot format to cell active time transmission and reception periods (e.g., the DTX and DRX cycle ON duration 302 and the DTX and DRX cycle ON duration 308) and a different slot format to cell non-active transmission periods and cell reception time periods (e.g., the DTX cycle OFF duration and DRX cycle ON duration 304).

The NE may indicate the association of slot formats to the cell DTX and DRX cycle configuration to one or more UEs semi-statically or dynamically according to the cell active DTX and DRX cycle configuration. For example, the NE may indicate the association via RRC signaling that includes configuration parameters defining which slot formats correspond to defined DTX and DRX cycle states, such as a slot format index parameter that maps to ON durations and OFF durations of the DTX and DRX cycles. Additionally, or alternatively, the NE may transmit DCI that includes slot format association fields, where each field includes an index or bitmap indicating a preconfigured slot format to apply during corresponding DTX and DRX cycle periods. The association parameters may include timing offset values that indicate when to transition between slot formats relative to DTX and DRX cycle boundaries, duration parameters that define how long each slot format remains active, and/or state mapping parameters that explicitly link slot format identifiers to DTX cycle ON durations, DTX cycle OFF durations, DRX cycle ON durations, and DRX cycle OFF durations. For example, the NE configures an early SFI for a subsequent cell active period using a semi-static or dynamic indication or using a WUS. In some examples, the NE configures multiple slot formats in a cell, and the NE can associate the slot formats to the one or more cell DTX and/or DRX cycle configurations.

In some cases, the NE can implement semi-static or periodic signaling (e.g., RRC signaling and/or a medium access control-control element (MAC-CE)) to associate slot formats to the one or more DTX and/or DRX cycle configurations of the NE and can subsequently update the associations dynamically (e.g., using a DCI). For example, the NE may transmit a DCI or other control signaling within an ON duration of a DTX cycle that triggers the UE to switch from a first slot format for the DTX cycle OFF duration and DRX cycle ON duration 304 to a second slot format for a DTX cycle OFF duration and DRX cycle ON duration 304. The dynamic switching capability provides for the UE and the NE to adapt to changing traffic conditions and interference patterns in real-time. Additionally, or alternatively, the NE can separately configure multiple slot formats dynamically according to the DTX and/or DRX cycle configurations of the NE, such as to prioritize uplink reception symbols 310 for the DTX cycle OFF duration and DRX cycle ON duration 304. The NE can configure the multiple slot formats as part of a DCI that activates a DTX cycle and/or DRX cycle of the NE. For example, the NE performs a joint activation of a DTX and DRX cycle of the NE and one or more associated slot formats. The joint activation reduces signaling overhead by combining cycle activation with slot format configuration in a single control message.

The NE may semi-statically configure (e.g., via RRC signaling and/or a MAC-CE) a UE with one or more durations of active, non-active transmission, and/or reception time periods of DTX and DRX cycles of the NE and slot formats with different downlink and uplink configurations, including time periods that the NE associates to the cell active and non-active transmission and/or reception periods. In some cases, the NE may configure a separate DCI field including an index to the slot format type that the NE associates to the DRX cycle of the NE. The DCI field may include a bitmap or index value that references a preconfigured set of slot formats. The NE may activate the DCI field if the NE activates a DRX cycle of the NE (e.g., active reception period). Once the NE activates the DCI including the DTX and/or DRX cycle configuration of the NE and one or more slot formats, until the UE receives a second DCI including deactivation or the NE semi-statically deactivates cell DTX cycle and/or DRX cycle configurations, the UE may follow the activated DTX and/or DRX cycle of the NE including transmission and reception duration and the associated slot format. If the NE enters a next active time period (e.g., the DTX and DRX cycle ON duration 308), then the NE and the UE autonomously (e.g., automatically, without additional communication) switch the slot format to the first slot format and the NE and the UE deactivate the second slot format.

In some examples, there may be a time period in which an NE may not transmit or receive, such as for the DTX and DRX cycle OFF duration 306. During such periods, both transmission and reception activities are suspended to achieve maximum power savings. The NE may associate a second format with the cell active reception and non-active transmission, such that there is no allocation for symbols 310 during the DTX and DRX cycle OFF duration 306. Additionally, or alternatively, the NE may configure special symbols or guard periods during the OFF duration to facilitate transitions between active and inactive states while maintaining synchronization.

In some cases, a second slot format type can override the first slot format type for a time duration equal to that of the cell non-active transmission and active reception period duration (e.g., the DTX cycle OFF duration and DRX cycle ON duration 304). The override mechanism ensures that a slot format is applied when the NE transitions between different DTX and DRX states. After the duration, the first slot format type may become active again as the cell enters the cell active time transmission and reception periods. A UE and/or an NE start a timer when the UE and/or the NE enter the DTX cycle OFF duration and DRX cycle ON duration 304. The UE and/or the NE may utilize the second slot format by deactivating the first slot format for a duration of the timer, where the duration of the timer is equal to the DTX cycle OFF duration and DRX cycle ON duration 304. The timer duration is configured based on the DTX and DRX cycle parameters, enabling accurate timing alignment. If the timer expires, then the UE and/or the NE deactivate the second slot format and the activate the first slot format. The timer expiration triggers an automatic return to a default slot format configuration.

If an NE configures the DTX cycle OFF duration and DRX cycle ON duration 304, then the UE can implicitly determine a second slot format. The implicit determination reduces signaling overhead by providing for the UE to derive slot format information from the DTX and DRX cycle configuration without explicit slot format signaling. For example, the UE may implicitly determine that one or more symbols 310 with active reception time periods and without active transmission time periods (e.g., the DTX cycle OFF duration and DRX cycle ON duration 304) are uplink symbols 310. The implicit mapping enables the UE to prioritize uplink transmission opportunities when the NE is not transmitting and is actively monitoring for uplink signals. In some examples, the NE provides multiple semi-static slot format types, where the NE associates each configuration to the cell activity or non-active periods. The semi-static configuration provides a predefined set of slot format options that can be activated without detailed slot format parameters in each activation message. If the UE and/or the NE enters active or non-active periods, then the UE implicitly activates a corresponding slot format. The implicit activation mechanism enables rapid slot format transitions based on defined associations between DTX and/or DRX states and slot format configurations.

In some cases, the NE may configure a UE to monitor for a DCI format including an SFI change as part of a search space monitoring occasion and periodicity configuration. The search space monitoring configuration defines one or more time-frequency resources where the UE monitors for control information. The NE may transmit the DCI format to the UE a numerical quantity of milliseconds (ms) (e.g., x ms) before an end of a cell active time transmission and reception periods. Otherwise, the UE may change the slot format x ms after the UE receives the DCI format including the SFI irrespective of the cell active or non-active time periods. In some cases, the NE may also signal the slot format change dynamically using lower power WUS (LPWUS) signaling and/or low power radio (LPR) signaling (e.g., for sequence based transmission). The LPWUS may be implemented using a separate low-power receiver chain at the UE that operates independently of a main receiver, enabling the UE to detect WUSs and slot format changes when the main receiver is in a power-saving state. The LPR signaling utilizes reduced transmission power and simplified signaling formats to convey control information with reduced energy consumption. The NE may implement LPWUS signaling by transmitting short duration signals with defined patterns that indicate slot format configurations, where each pattern corresponds to a different slot format type associated with DTX and DRX cycle states. The UE may implement LPWUS reception by maintaining a low-power monitoring function that periodically checks for WUSs and decodes the associated slot format information, then activates the main receiver with a corresponding slot format configuration. For LPR signaling, the NE may implement sequence-based transmission, where control information is encoded using defined sequences, and the UE may implement LPR reception by correlating received signals against known sequence patterns to extract slot format control information. The NE may represent each group of bits by a sequence, such as ‘0001’ by sequence 1, ‘0010’ by sequence 2, and so on. In some examples, the NE and/or the UE may utilize any combination of explicit and/or implicit slot format configuration to align the slot formats with DTX and/or DRX cycles of the NE.

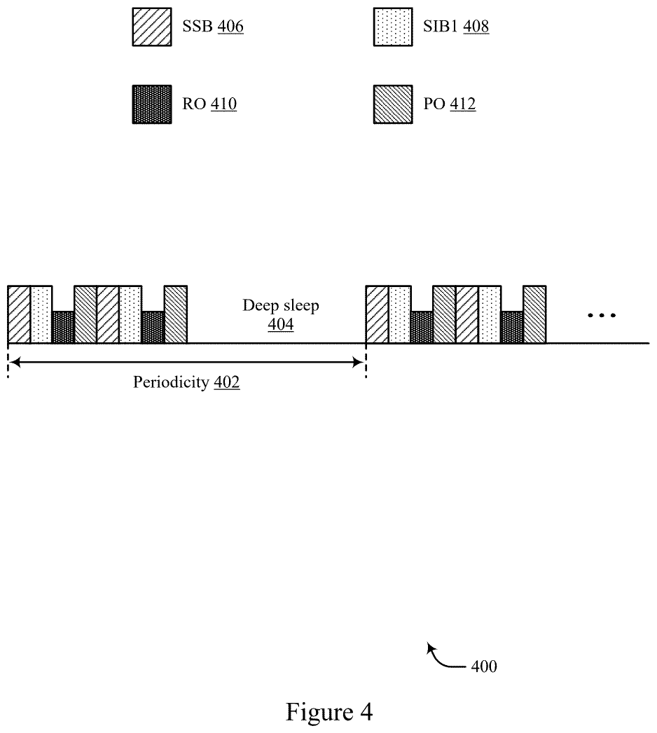

FIG. 4 illustrates an example of a transmission diagram 400 in accordance with aspects of the present disclosure. In some examples, the transmission diagram 400 implements or is implemented by aspects of the wireless communications system 100, the transmission diagram 200, and/or the transmission diagram 300. For example, the transmission diagram 400 may be implemented by one or more UEs and/or NEs, which may be an example of NEs 102 and UEs 104 as described with reference to FIG. 1. The transmission diagram 400 illustrates an example of a common channel and slot format type.

In some examples, an NE may configure slot formats that align with common channel and signal transmission patterns, where the NE transmits common channels and signals during defined time periods and enters a sleep state during other time periods. In some cases, the common channel and signals may be repeated according to a periodicity 402. The periodicity 402 represents a time interval during which the NE performs transmission and reception of common channels and signals, followed by the deep sleep period 404 during which the NE operates in a low power state. During the deep sleep period 404, the NE may deactivate or suspend one or more functional components, including transmission and reception circuitry, to conserve energy. Within each periodicity 402, the NE may transmit one or more common channels and signals, including synchronization signal blocks (SSBs) 406, system information blocks (SIBs) (e.g., one or more SIB1s 408), random access channel (RACH) occasions (ROs) 410, and/or paging occasions (POs) 412. The periodicity 402 may be configured based on network traffic patterns, UE density, or power saving criterion. The common channels and signals are arranged in clusters within the periodicity 402. Each cluster includes a sequence of SSBs 406, SIB1s 408, ROs 410, and POs 412, enabling the NE to group related signaling activities together before entering the deep sleep period 404.

In some examples, an NE may provide a UE with an SFI for a subsequent ON duration for a DRX and/or DTX cycle of the NE (e.g., a next active transmission and reception periods of the NE). The NE may provide the indication at an earlier cell active period, and/or the NE may provide the indication using a WUS as part of LPWUS signaling and/or LPR signaling. For example, the SFI may include information about which slot format to apply during the next active period. The early indication mechanism reduces latency by providing for the UE to configure slot formats before the active period begins.

The NE may configure a first slot format type that includes downlink and uplink symbols and/or slots associated with the common channel and signal transmission and reception periods within the periodicity 402. The NE may associate downlink slots with common channels and signals, such as the SSBs 406, the SIB1s 408, and/or the POs 412, and may associate uplink slots with the ROs 410. For example, the SSBs 406 may be transmitted in downlink slots to provide synchronization information to UEs, the SIB1s 408 may be transmitted in downlink slots to convey system information, the POs 412 may be transmitted in downlink slots for paging messages, and the ROs 410 may be allocated in uplink slots to enable UEs to initiate random access procedures. The NE may configure a UE with the slot format type including downlink and uplink slots and/or symbols associated with a common channel or signal cluster periodicity (e.g., the periodicity 402) and transmission and reception duration within the cluster. The slot format configuration may indicate the timing and duration of each common channel and signal within the periodicity 402, providing coordination between the NE and UE. In some cases, if the NE semi-statically configures the periodicity 402 and pattern of signals at a UE, then the UE may implicitly activate the first slot format type during the common channel and signal transmission and reception periods and may autonomously deactivate or switch to a second slot format type for UE-specific traffic after the common channels and signals. The implicit activation reduces signaling overhead by reducing or eliminating explicit slot format activation commands for each periodicity 402. In some other cases, the NE may configure a UE with a second slot format type semi-statically or dynamically when UE specific transmission and reception occur after the common channel and/or signal transmission and reception. The dynamic configuration enables the NE to adapt slot formats based on current traffic conditions and UE criterion following the common channel transmission period.

In some examples, the NE may configure a third slot format type that includes uplink slots and symbols at a UE. The UE may use the third slot format type to transmit uplink WUSs when an NE may operate in a deep sleep state (e.g., during the deep sleep period 404). An NE may run a low power wake up receiver during a deep sleep period 404, and the NE may actively monitor for uplink WUSs in the uplink slots. A low power wake up receiver operates independently of the main receiver circuitry, consuming significantly less power while maintaining the ability to detect WUSs. The UE may use the uplink WUSs to wake up the NE transmitter to send one or more on-demand common channels and/or signals (e.g., the SSBs 406, SIB1s 408, POs 412, etc.). The UE may autonomously switch or dynamically switch to the third slot format type. The NE may monitor the uplink WUS using a configured duty cycle, and the NE may implicitly activate and deactivate the third slot format type when the NE monitors uplink WUS or when the NE does not monitor and/or enters a cell active time period (e.g., ON duration), respectively.

In some cases, if an NE configures one or more UEs using a DTX cycle of the NE with an ON duration (e.g., cell active transmission period) while a DRX cycle is in an OFF duration (e.g., cell non-active reception period) for an overlapping numerical quantity of slots, then a UE may autonomously switch downlink slots for the numerical quantity of slots (e.g., a duration). In some other cases, the NE may dynamically transmit signaling to the UE that indicates for the UE to switch downlink slots. The signaling may include a DCI (e.g., a cell DTX-DRX DCI), a MAC-CE activation, and/or a semi-statically configured slot format according to the DRX cycle and/or DTX cycle. In some examples, 5G NR configures a separate RNTI for a DTX cycle and/or a DRX of an NE and a slot format type indication because of different DCI formats. The NE may configure the UEs with a new RNTI because of the combined DCI format configuring both the DTX cycle and/or the DRX cycle of the NE and slot format type indication monitoring.

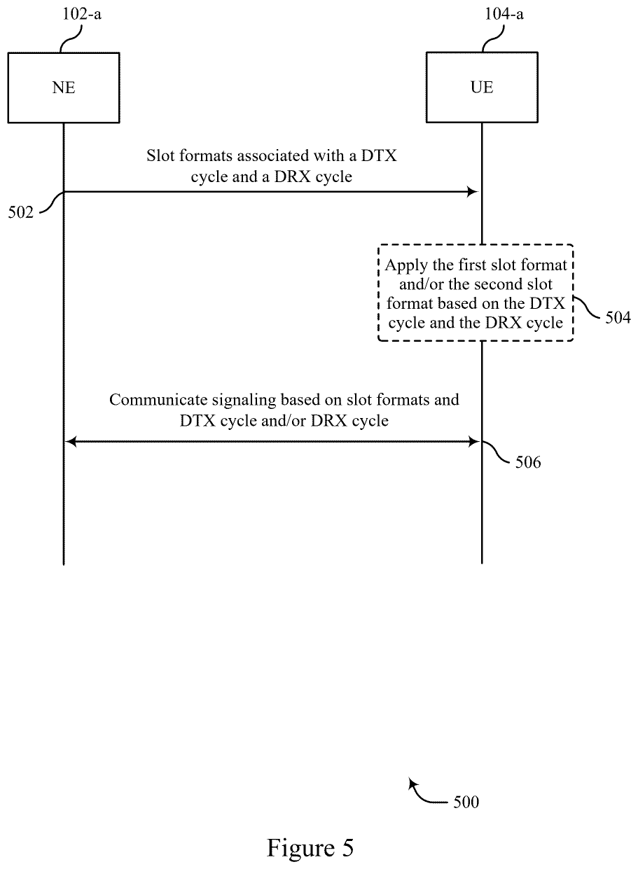

FIG. 5 illustrates an example of a signaling diagram 500 in accordance with aspects of the present disclosure. In some examples, the signaling diagram 500 implements or is implemented by aspects of the wireless communications system 100 and/or the transmission diagram 200 through the transmission diagram 400. The signaling diagram 500 may implement or be implemented by one or more devices, such as an NE 102-a and a UE 104-a, which may be examples of an NE 102 and a UE 104 as described with reference to FIG. 1. The signaling diagram 500 may illustrate an example of configuring multiple slot formats to align with different durations of DTX and DRX cycles in wireless communications. Alternative examples of the following may be implemented, where some processes are performed in a different order than described or are not performed. In some cases, processes may include additional features not mentioned below, or further processes may be added.

At 502, the NE 102-a transmits first signaling that indicates a set of slot formats for a DTX cycle and a DRX cycle of the NE 102-a to the UE 104-a. The set of slot formats includes a first slot format for an ON duration of at least one of the DTX cycle or the DRX cycle and a second slot format for an OFF duration of the at least one of the DTX cycle or the DRX cycle. The first signaling may include one or more DCI that indicate the first slot format and the second slot format. For example, the first signaling may include a first DCI that indicates the first slot format and a second DCI (e.g., received after the first DCI) that indicates the second slot format. In some examples, the one or more DCI include a dedicated DCI transmitted during the ON duration of the DTX cycle and a common DCI transmitted prior to an ON duration of the DTX cycle or an ON duration of the DRX cycle. Dedicated DCI may be transmitted to a defined UE or a defined group of UEs, where the dedicated DCI is intended for reception by the defined UE or the defined group of UEs. The dedicated DCI may be transmitted during an ON duration of a discontinuous transmission cycle or a discontinuous reception cycle to provide control information for scheduling, resource allocation, or configuration updates. In some examples, the dedicated DCI may include DCI format 1_0, DCI format 1_1, DCI format 1_2, DCI format 0_0, DCI format 0_1, and/or DCI format 0_2, among other formats. The dedicated DCI may be scrambled with a cell-RNTI (C-RNTI), a configured scheduling-RNTI (CS-RNTI), or another UE-specific identifier to enable the defined UE to identify and decode the control information. Common DCI may be transmitted to multiple UEs within a cell or a group of cells, where the common DCI is intended for reception by the multiple UEs, rather than a defined UE. The common DCI may be transmitted prior to an ON duration of a discontinuous transmission cycle or a discontinuous reception cycle to provide control information for system-level configurations, slot format indications, power control commands, or other signaling. In some examples, the common DCI may include DCI format 2_0, DCI format 2_1, DCI format 2_2, DCI format 2_3, DCI format 2_4, DCI format 2_5, or DCI format 2_9, among other formats. The common DCI may be scrambled with an SFI-RNTI or another group-common identifier to enable the multiple UEs to identify and decode the control information.

Additionally, or alternatively, the NE 102-a may transmit RRC signaling including respective sets of slot formats for a set of DTX cycles and DRX cycles. The respective sets of slot formats include the set of slot formats. In some cases, the RRC signaling is transmitted prior to the first signaling, and the first signaling includes at least one DCI that activates at least one of the first slot format or the second slot format. In some other cases, the first signaling includes the RRC signaling, enabling the UE 104-a to apply at least one of the first slot format or the second slot format based in part on (or according to) the DTX cycle and the DRX cycle (e.g., implicitly based on the DTX cycle and the DRX cycle, rather than explicitly as indicated in dynamic control signaling). The UE 104-a applies the first slot format and/or the second slot format for one or more durations of subsequent signaling.

At 504, the UE 104-a applies the first slot format and/or the second slot format based in part on (or according to) the DTX cycle and the DRX cycle. The UE 104-a determines which slot format to apply depending on whether the NE 102-a is in an ON duration or an OFF duration of the respective DTX or DRX cycle. In some cases, the DTX and DRX cycles may align, such that there is a DTX and DRX cycle ON duration in which both cycles are active. The DTX cycle OFF duration and DRX cycle ON duration may overlap, where the DTX cycle is inactive while the DRX cycle remains active. The DTX and DRX cycle OFF durations may overlap, where both cycles are inactive. Each of the durations spans one or more symbols that are configured according to the applied slot format. In some examples, the UE 104-a applies the second slot format for a first duration during an OFF duration of the DTX cycle and an ON duration of the DRX cycle. The ON duration of the DRX cycle overlaps with the OFF duration of the DTX cycle. After the first duration, the UE 104-a applies the first slot format for a second duration during an ON duration of the DTX cycle and the ON duration of the DRX cycle, as described with reference to FIG. 3. Additionally, or alternatively, the UE 104-a may apply the second slot format to one or more slots during an ON duration of a DTX cycle. The one or more slots include uplink slots. In some cases, the UE 104-a applies at least one of the first slot format or the second slot format a threshold duration after receiving the first signaling. The threshold duration is determined by a current ON duration of at least one of the DTX cycle or the DRX cycle or a subsequent ON duration of at least one of the DTX cycle or the DRX cycle.

At 506, the NE 102-a and the UE 104-a communicate second signaling using the slot formats and the DTX cycle and/or DRX cycle. The communication occurs according to the applied slot formats, enabling coordinated transmission and reception activities that align with the timing of the DTX and DRX cycles. In some cases, the NE 102-a may implement slot formats that coordinate with common channel and signal transmission patterns, where the NE 102-a transmits common channels and signals during defined periodicities and enters a deep sleep period during other time periods, as described with reference to FIG. 4. Within each periodicity, the NE 102-a may transmit common channels and signals, including, but not limited to, SSBs, SIB1s, ROs, and POs, where the slot format indicates which symbols are designated for downlink transmission (e.g., for the SSBs, SIB1s, and POs) and which symbols are designated for uplink transmission (e.g., for the ROs). To communicate the second signaling, the UE 104-a may receive the second signaling using the first slot format during an ON duration of the DTX cycle. Additionally, or alternatively, the UE 104-a may transmit the second signaling using the first slot format during an ON duration of the DRX cycle. Additionally, or alternatively, the UE 104-a may receive the second signaling using the second slot format during an OFF duration of the DRX cycle. Additionally, or alternatively, the UE 104-a may transmit the second signaling using the second slot format during an OFF duration of the DTX cycle. The signaling exchanged at 506 may include control information, data transmissions, and/or other wireless communications that utilize the configured slot formats to improve resource utilization and power efficiency. The coordination between slot format selection and DTX and DRX cycle timing enables the NE 102-a and the UE 104-a to achieve improved communication performance during active periods (e.g., ON durations), while conserving power during inactive periods (e.g., OFF durations).

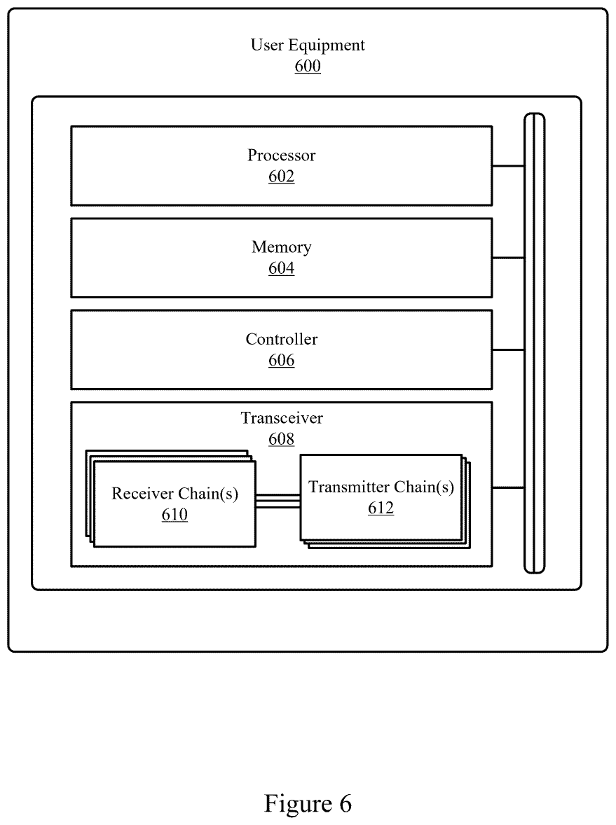

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field-programmable gate-array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving first signaling that indicates a set of slot formats associated with a DTX cycle and a DRX cycle corresponding to an NE, where the set of slot formats includes a first slot format associated with an ON duration of at least one of the DTX cycle or the DRX cycle and a second slot format associated with an OFF duration of the at least one of the DTX cycle or the DRX cycle, and communicating, based on the ON duration of the at least one of the DTX cycle or the DRX cycle, second signaling based on the first slot format and the second slot format. In this manner, the UE 600 achieves improved resource utilization and power efficiency by coordinating slot format selection with DTX and DRX cycles, reducing latency during active periods and conserving power during inactive periods.

Additionally, the UE 600 may be configured to or operable to support any one or combination of the first signaling includes one or more DCI that indicate the first slot format and the second slot format. This aspect enables dynamic slot format activation through control signaling, improving system responsiveness and providing for real-time adaptation to changing DTX and DRX conditions. Additionally, or alternatively, the UE 600 may be configured to or operable to support the one or more DCI include a dedicated DCI received during the ON duration of the DTX cycle and a common DCI received prior to an ON duration of the DTX cycle or an ON duration of the DRX cycle. This aspect provides flexible signaling mechanisms that improve control overhead by using dedicated signaling during active periods and common signaling for advance configuration. Additionally, or alternatively, the UE 600 may be configured to or operable to support receiving RRC signaling including respective sets of slot formats associated with a set of DTX cycles and DRX cycles, where the respective sets of slot formats include the set of slot formats. This aspect enables comprehensive slot format configuration across multiple DTX and DRX cycles, reducing signaling overhead and improving coordination efficiency. Additionally, or alternatively, the UE 600 may be configured to or operable to support the RRC signaling is received prior to the first signaling, and where the first signaling includes at least one DCI that activates the first slot format and the second slot format. This aspect separates configuration from activation, reducing control signaling latency by preconfiguring slot formats and enabling selective activation. Additionally, or alternatively, the UE 600 may be configured to or operable to support the first signaling includes the RRC signaling, and applying, based on the DTX cycle and the DRX cycle, at least one of the first slot format or the second slot format for one or more durations associated with the second signaling. This aspect enables direct configuration and application of slot formats, reducing signaling complexity and improving system responsiveness by reducing or eliminating separate activation steps.

Additionally, or alternatively, the UE 600 may be configured to or operable to support to communicate the second signaling includes at least one of receiving, during an ON duration of the DTX cycle, the second signaling based on the first slot format, transmitting, during an ON duration of the DRX cycle, the second signaling based on the first slot format, receiving, during an OFF duration of the DRX cycle, the second signaling based on the second slot format, or transmitting, during an OFF duration of the DTX cycle, the second signaling based on the second slot format. This aspect improves communication patterns by aligning slot formats with DTX and DRX states, improving throughput during active periods and maintaining communication capability during inactive periods. Additionally, or alternatively, the UE 600 may be configured to or operable to support applying the second slot format for a first duration corresponding to an OFF duration of the DTX cycle and an ON duration of the DRX cycle, where the ON duration of the DRX cycle overlaps with the OFF duration of the DTX cycle, and applying, after the first duration, the first slot format for a second duration corresponding to an ON duration of the DTX cycle and the ON duration of the DRX cycle. This aspect handles overlapping DTX and DRX cycles efficiently, improving resource allocation during complex timing scenarios and preventing resource conflicts. Additionally, or alternatively, the UE 600 may be configured to or operable to support applying the second slot format to one or more slots associated with an ON duration of a DTX cycle, where the one or more slots include uplink slots. This aspect enables flexible uplink transmission during DTX active periods using alternative slot formats, improving uplink throughput and communication reliability. Additionally, or alternatively, the UE 600 may be configured to or operable to support applying at least one of the first slot format or the second slot format a threshold duration after receiving the first signaling, where the threshold duration is based on a current ON duration of at least one of the DTX cycle or the DRX cycle or a subsequent ON duration of at least one of the DTX cycle or the DRX cycle. This aspect provides timing flexibility for slot format application, reducing implementation complexity and ensuring synchronization with DTX and DRX timing criterion.

Additionally, or alternatively, the UE 600 may support at least one memory (e.g., the memory 604) and at least one processor (e.g., the processor 602) coupled with the at least one memory and configured to or operable to cause the UE to receive first signaling that indicates a set of slot formats associated with a DTX cycle and a DRX cycle corresponding to an NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format.

Additionally, the UE 600 may be configured to or operable to support any one or combination of the first signaling includes one or more DCI that indicate the first slot format and the second slot format. Additionally, or alternatively, the UE 600 may be configured to or operable to support the one or more DCI include a dedicated DCI received during the ON duration of the DTX cycle and a common DCI received prior to an ON duration of the DTX cycle or an ON duration of the DRX cycle. Additionally, or alternatively, the UE 600 may be configured to or operable to support to receive RRC signaling including respective sets of slot formats associated with a set of DTX cycles and DRX cycles, where the respective sets of slot formats include the set of slot formats. Additionally, or alternatively, the UE 600 may be configured to or operable to support the RRC signaling is received prior to the first signaling, and where the first signaling includes at least one DCI that activates the first slot format and the second slot format. Additionally, or alternatively, the UE 600 may be configured to or operable to support the first signaling includes the RRC signaling, and to apply, based on the DTX cycle and the DRX cycle, at least one of the first slot format or the second slot format for one or more durations associated with the second signaling.

Additionally, or alternatively, to communicate the second signaling, the UE 600 may be configured to or operable to support to at least one of receive, during an ON duration of the DTX cycle, the second signaling based on the first slot format, transmit, during an ON duration of the DRX cycle, the second signaling based on the first slot format, receive, during an OFF duration of the DRX cycle, the second signaling based on the second slot format, or transmit, during an OFF duration of the DTX cycle, the second signaling based on the second slot format. Additionally, or alternatively, the UE 600 may be configured to or operable to support to apply the second slot format for a first duration corresponding to an OFF duration of the DTX cycle and an ON duration of the DRX cycle, where the ON duration of the DRX cycle overlaps with the OFF duration of the DTX cycle, and apply, after the first duration, the first slot format for a second duration corresponding to an ON duration of the DTX cycle and the ON duration of the DRX cycle. Additionally, or alternatively, the UE 600 may be configured to or operable to support to apply the second slot format to one or more slots associated with an ON duration of a DTX cycle, where the one or more slots include uplink slots. Additionally, or alternatively, the UE 600 may be configured to or operable to support to apply at least one of the first slot format or the second slot format a threshold duration after receiving the first signaling, where the threshold duration is based on a current ON duration of at least one of the DTX cycle or the DRX cycle or a subsequent ON duration of at least one of the DTX cycle or the DRX cycle.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

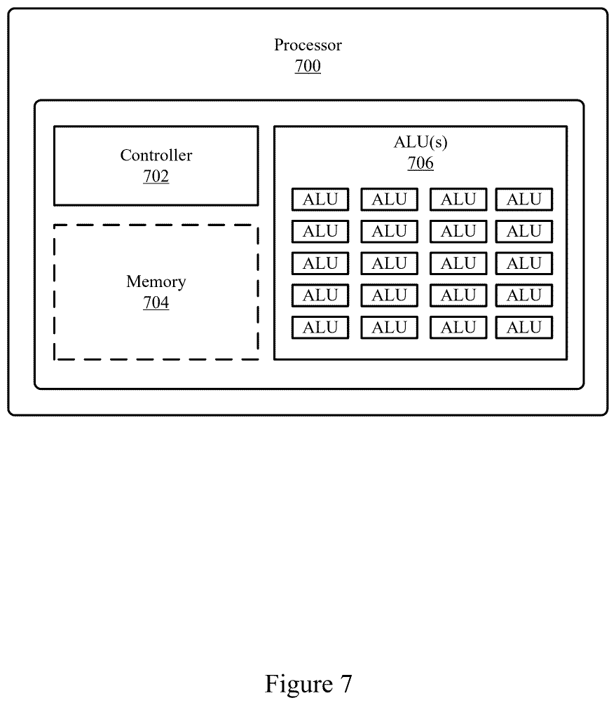

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive first signaling that indicates a set of slot formats associated with a DTX cycle and a DRX cycle corresponding to an NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format. In this manner, the processor 700 achieves improved resource utilization and power efficiency by coordinating slot format selection with DTX and DRX cycles, reducing latency during active periods and conserving power during inactive periods.

Additionally, the processor 700 may be configured to or operable to support any one or combination of the first signaling includes one or more DCI that indicate the first slot format and the second slot format. This aspect enables dynamic slot format activation through control signaling, improving system responsiveness and providing for real-time adaptation to changing DTX and DRX conditions. Additionally, or alternatively, the processor 700 may be configured to or operable to support the one or more DCI include a dedicated DCI received during the ON duration of the DTX cycle and a common DCI received prior to an ON duration of the DTX cycle or an ON duration of the DRX cycle. This aspect provides flexible signaling mechanisms that improve control overhead by using dedicated signaling during active periods and common signaling for advance configuration. Additionally, or alternatively, the processor 700 may be configured to or operable to support to receive RRC signaling including respective sets of slot formats associated with a set of DTX cycles and DRX cycles, where the respective sets of slot formats include the set of slot formats. This aspect enables comprehensive slot format configuration across multiple DTX and DRX cycles, reducing signaling overhead and improving coordination efficiency. Additionally, or alternatively, the processor 700 may be configured to or operable to support the RRC signaling is received prior to the first signaling, and where the first signaling includes at least one DCI that activates the first slot format and the second slot format. This aspect separates configuration from activation, reducing control signaling latency by preconfiguring slot formats and enabling selective activation. Additionally, or alternatively, the processor 700 may be configured to or operable to support the first signaling includes the RRC signaling, and to apply, based on the DTX cycle and the DRX cycle, at least one of the first slot format or the second slot format for one or more durations associated with the second signaling. This aspect enables direct configuration and application of slot formats, reducing signaling complexity and improving system responsiveness by reducing or eliminating separate activation steps.

Additionally, or alternatively, the processor 700 may be configured to or operable to support to communicate the second signaling includes to at least one of receive, during an ON duration of the DTX cycle, the second signaling based on the first slot format, transmit, during an ON duration of the DRX cycle, the second signaling based on the first slot format, receive, during an OFF duration of the DRX cycle, the second signaling based on the second slot format, or transmit, during an OFF duration of the DTX cycle, the second signaling based on the second slot format. This aspect improves communication patterns by aligning slot formats with DTX and DRX states, improving throughput during active periods and maintaining communication capability during inactive periods. Additionally, or alternatively, the processor 700 may be configured to or operable to support to apply the second slot format for a first duration corresponding to an OFF duration of the DTX cycle and an ON duration of the DRX cycle, where the ON duration of the DRX cycle overlaps with the OFF duration of the DTX cycle, and apply, after the first duration, the first slot format for a second duration corresponding to an ON duration of the DTX cycle and the ON duration of the DRX cycle. This aspect handles overlapping DTX and DRX cycles efficiently, improving resource allocation during complex timing scenarios and preventing resource conflicts. Additionally, or alternatively, the processor 700 may be configured to or operable to support to apply the second slot format to one or more slots associated with an ON duration of a DTX cycle, where the one or more slots include uplink slots. This aspect enables flexible uplink transmission during DTX active periods using alternative slot formats, improving uplink throughput and communication reliability. Additionally, or alternatively, the processor 700 may be configured to or operable to support to apply at least one of the first slot format or the second slot format a threshold duration after receiving the first signaling, where the threshold duration is based on a current ON duration of at least one of the DTX cycle or the DRX cycle or a subsequent ON duration of at least one of the DTX cycle or the DRX cycle. This aspect provides timing flexibility for slot format application, reducing implementation complexity and ensuring synchronization with DTX and DRX timing criterion.

The processor 700 may be configured to or operable to support at least one controller (e.g., the controller 702) coupled with at least one memory (e.g., the memory 704) and configured to cause the processor to transmit first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format. In this manner, the processor 700 achieves improved resource allocation and power efficiency by coordinating slot format selection with DTX and DRX cycles, reducing latency during active periods and conserving power during inactive periods.

Additionally, the processor 700 may be configured to or operable to support any one or combination of the first signaling includes one or more DCI that indicate the first slot format and the second slot format. This aspect enables dynamic slot format activation through control signaling, improving system responsiveness and providing for real-time adaptation to changing DTX and DRX conditions. Additionally, or alternatively, the processor 700 may be configured to or operable to support the one or more DCI include a dedicated DCI received during the ON duration of the DTX cycle and a common DCI received prior to an ON duration of the DTX cycle or an ON duration of the DRX cycle. This aspect provides flexible signaling mechanisms that improve control overhead by using dedicated signaling during active periods and common signaling for advance configuration. Additionally, or alternatively, the processor 700 may be configured to or operable to support to transmit RRC signaling including respective sets of slot formats associated with a set of DTX cycles and DRX cycles, where the respective sets of slot formats include the set of slot formats. This aspect enables comprehensive slot format configuration across multiple DTX and DRX cycles, reducing signaling overhead and improving coordination efficiency.

Additionally, or alternatively, the processor 700 may be configured to or operable to support to communicate the second signaling includes to at least one of transmit, during an ON duration of the DTX cycle, the second signaling based on the first slot format, receive, during an ON duration of the DRX cycle, the second signaling based on the first slot format, transmit, during an OFF duration of the DRX cycle, the second signaling based on the second slot format, or receive, during an OFF duration of the DTX cycle, the second signaling based on the second slot format. This aspect improves communication patterns by aligning slot formats with DTX and DRX states, improving throughput during active periods and maintaining communication capability during inactive periods. Additionally, or alternatively, the processor 700 may be configured to or operable to support to apply the second slot format for a first duration corresponding to an OFF duration of the DTX cycle and an ON duration of the DRX cycle, where the ON duration of the DRX cycle overlaps with the OFF duration of the DTX cycle, and apply, after the first duration, the first slot format for a second duration corresponding to an ON duration of the DTX cycle and the ON duration of the DRX cycle. This aspect handles overlapping DTX and DRX cycles efficiently, improving resource allocation during complex timing scenarios and preventing resource conflicts. Additionally, or alternatively, the processor 700 may be configured to or operable to support to apply the second slot format to one or more slots associated with an ON duration of a DTX cycle, where the one or more slots include uplink slots. This aspect enables flexible uplink transmission during DTX active periods using alternative slot formats, improving uplink throughput and communication reliability. Additionally, or alternatively, the processor 700 may be configured to or operable to support to apply at least one of the first slot format or the second slot format a threshold duration after transmitting the first signaling, where the threshold duration is based on a current ON duration of at least one of the DTX cycle or the DRX cycle or a subsequent ON duration of at least one of the DTX cycle or the DRX cycle. This aspect provides timing flexibility for slot format application, reducing implementation complexity and ensuring synchronization with DTX and DRX timing criterion.

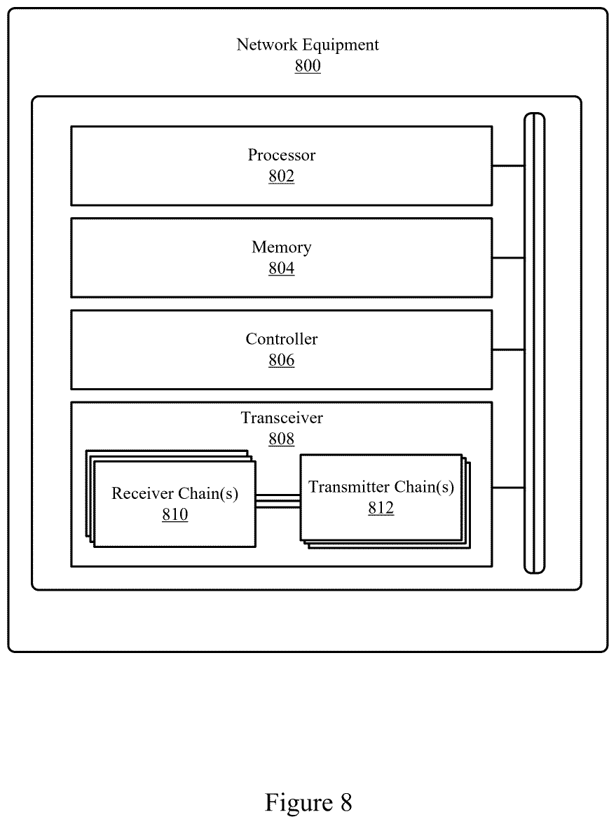

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle, and communicating, based on the ON duration of the at least one of the DTX cycle or the DRX cycle, second signaling based on the first slot format and the second slot format. In this manner, the NE 800 achieves improved resource allocation and power efficiency by coordinating slot format selection with DTX and DRX cycles, reducing latency during active periods and conserving power during inactive periods.

Additionally, the NE 800 may be configured to or operable to support any one or combination of the first signaling includes one or more DCI that indicate the first slot format and the second slot format. This aspect enables dynamic slot format activation through control signaling, improving system responsiveness and providing for real-time adaptation to changing DTX and DRX conditions. Additionally, or alternatively, the NE 800 may be configured to or operable to support the one or more DCI include a dedicated DCI received during the ON duration of the DTX cycle and a common DCI received prior to an ON duration of the DTX cycle or an ON duration of the DRX cycle. This aspect provides flexible signaling mechanisms that improve control overhead by using dedicated signaling during active periods and common signaling for advance configuration. Additionally, or alternatively, the NE 800 may be configured to or operable to support transmitting RRC signaling including respective sets of slot formats associated with a set of DTX cycles and DRX cycles, where the respective sets of slot formats include the set of slot formats. This aspect enables comprehensive slot format configuration across multiple DTX and DRX cycles, reducing signaling overhead and improving coordination efficiency.

Additionally, or alternatively, the NE 800 may be configured to or operable to support to communicate the second signaling includes at least one of transmitting, during an ON duration of the DTX cycle, the second signaling based on the first slot format, receiving, during an ON duration of the DRX cycle, the second signaling based on the first slot format, transmitting, during an OFF duration of the DRX cycle, the second signaling based on the second slot format, or receiving, during an OFF duration of the DTX cycle, the second signaling based on the second slot format. This aspect improves communication patterns by aligning slot formats with DTX and DRX states, improving throughput during active periods and maintaining communication capability during inactive periods. Additionally, or alternatively, the NE 800 may be configured to or operable to support applying the second slot format for a first duration corresponding to an OFF duration of the DTX cycle and an ON duration of the DRX cycle, where the ON duration of the DRX cycle overlaps with the OFF duration of the DTX cycle, and applying, after the first duration, the first slot format for a second duration corresponding to an ON duration of the DTX cycle and the ON duration of the DRX cycle. This aspect handles overlapping DTX and DRX cycles efficiently, improving resource allocation during complex timing scenarios and preventing resource conflicts. Additionally, or alternatively, the NE 800 may be configured to or operable to support applying the second slot format to one or more slots associated with an ON duration of a DTX cycle, where the one or more slots include uplink slots. This aspect enables flexible uplink transmission during DTX active periods using alternative slot formats, improving uplink throughput and communication reliability. Additionally, or alternatively, the NE 800 may be configured to or operable to support applying at least one of the first slot format or the second slot format a threshold duration after transmitting the first signaling, where the threshold duration is based on a current ON duration of at least one of the DTX cycle or the DRX cycle or a subsequent ON duration of at least one of the DTX cycle or the DRX cycle. This aspect provides timing flexibility for slot format application, reducing implementation complexity and ensuring synchronization with DTX and DRX timing criterion.

Additionally, or alternatively, the NE 800 may support at least one memory (e.g., the memory 804) and at least one processor (e.g., the processor 802) coupled with the at least one memory and configured to or operable to cause the NE to transmit first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle, and communicate, based on the ON duration of the at least one of the DTX cycle or the DRX cycle, second signaling based on the first slot format and the second slot format.

Additionally, the NE 800 may be configured to support any one or combination of the first signaling includes one or more DCI that indicate the first slot format and the second slot format. Additionally, or alternatively, the NE 800 may be configured to support the one or more DCI include a dedicated DCI received during the ON duration of the DTX cycle and a common DCI received prior to an ON duration of the DTX cycle or an ON duration of the DRX cycle. Additionally, or alternatively, the NE 800 may be configured to support to transmit RRC signaling including respective sets of slot formats associated with a set of DTX cycles and DRX cycles, where the respective sets of slot formats include the set of slot formats. Additionally, or alternatively, the NE 800 may be configured to support to communicate the second signaling includes at least one of transmitting, during an ON duration of the DTX cycle, the second signaling based on the first slot format, receiving, during an ON duration of the DRX cycle, the second signaling based on the first slot format, transmitting, during an OFF duration of the DRX cycle, the second signaling based on the second slot format, or receiving, during an OFF duration of the DTX cycle, the second signaling based on the second slot format.

Additionally, or alternatively, the NE 800 may be configured to support to apply the second slot format for a first duration corresponding to an OFF duration of the DTX cycle and an ON duration of the DRX cycle, where the ON duration of the DRX cycle overlaps with the OFF duration of the DTX cycle, and apply, after the first duration, the first slot format for a second duration corresponding to an ON duration of the DTX cycle and the ON duration of the DRX cycle. Additionally, or alternatively, the NE 800 may be configured to support to apply the second slot format to one or more slots associated with an ON duration of a DTX cycle, where the one or more slots include uplink slots. Additionally, or alternatively, the NE 800 may be configured to support to apply at least one of the first slot format or the second slot format a threshold duration after transmitting the first signaling, where the threshold duration is based on a current ON duration of at least one of the DTX cycle or the DRX cycle or a subsequent ON duration of at least one of the DTX cycle or the DRX cycle.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., an LNA) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

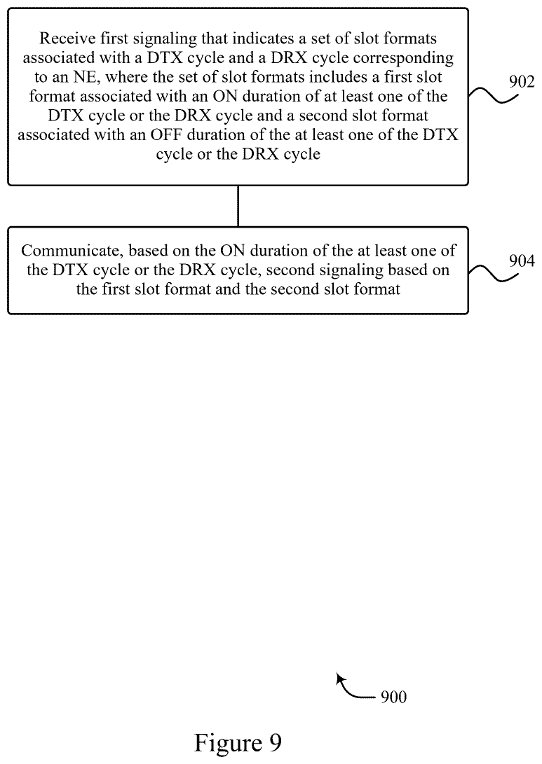

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving first signaling that indicates a set of slot formats associated with a DTX cycle and a DRX cycle corresponding to an NE, where the set of slot formats includes a first slot format associated with an ON duration of at least one of the DTX cycle or the DRX cycle and a second slot format associated with an OFF duration of the at least one of the DTX cycle or the DRX cycle. The operations of 902 may be performed in accordance with examples as described herein. In some implementations, aspects of the operations of 902 may be performed by a UE as described with reference to FIG. 6.

At 904, the method may include communicating, based on the ON duration of the at least one of the DTX cycle or the DRX cycle, second signaling based on the first slot format and the second slot format. The operations of 904 may be performed in accordance with examples as described herein. In some implementations, aspects of the operations of 904 may be performed by a UE as described with reference to FIG. 6.

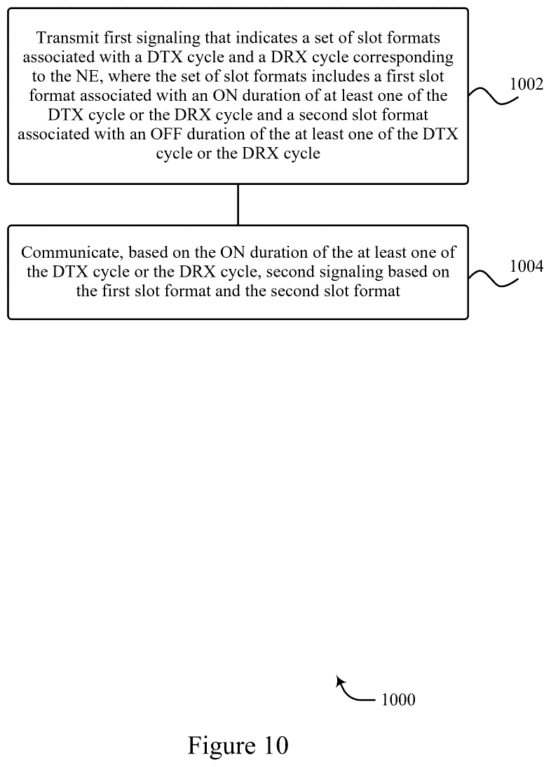

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include communicating, based on the ON duration of the at least one of the DTX cycle or the DRX cycle, second signaling based on the first slot format and the second slot format. The operations of 1002 may be performed in accordance with examples as described herein. In some implementations, aspects of the operations of 1002 may be performed by an NE as described with reference to FIG. 8.

At 1004, the method may include transmitting first signaling that indicates a set of slot formats associated with a DTX cycle and a DRX cycle corresponding to the NE, where the set of slot formats includes a first slot format associated with an ON duration of at least one of the DTX cycle or the DRX cycle and a second slot format associated with an OFF duration of the at least one of the DTX cycle or the DRX cycle. The operations of 1004 may be performed in accordance with examples as described herein. In some implementations, aspects of the operations of 1004 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive first signaling that indicates a plurality of slot formats associated with a discontinuous transmission (DTX) cycle and a discontinuous reception (DRX) cycle corresponding to a network equipment (NE), wherein the plurality of slot formats comprises a first slot format associated with an ON duration of at least one of the DTX cycle or the DRX cycle and a second slot format associated with an OFF duration of the at least one of the DTX cycle or the DRX cycle; and
communicate, based at least in part on the ON duration of the at least one of the DTX cycle or the DRX cycle, second signaling based at least in part on the first slot format and the second slot format.

2. The UE of claim 1, wherein the first signaling comprises one or more downlink control information (DCI) that indicate the first slot format and the second slot format.

3. The UE of claim 2, wherein the one or more DCI comprise a dedicated DCI received during the ON duration of the DTX cycle and a common DCI received prior to an ON duration of the DTX cycle or an ON duration of the DRX cycle.

4. The UE of claim 1, wherein the at least one processor is further operable to cause the UE to receive radio resource control (RRC) signaling comprising respective pluralities of slot formats associated with a plurality of DTX cycles and DRX cycles, wherein the respective pluralities of slot formats comprise the plurality of slot formats.

5. The UE of claim 4, wherein the RRC signaling is received prior to the first signaling, and wherein the first signaling comprises at least one downlink control information (DCI) that activates the first slot format and the second slot format.

6. The UE of claim 4, wherein the first signaling comprises the RRC signaling, and wherein the at least one processor is further operable to cause the UE to apply, based at least in part on the DTX cycle and the DRX cycle, at least one of the first slot format or the second slot format for one or more durations associated with the second signaling.

7. The UE of claim 1, wherein to communicate the second signaling, the at least one processor is operable to cause the UE to at least one of:
receive, during an ON duration of the DTX cycle, the second signaling based at least in part on the first slot format;
transmit, during an ON duration of the DRX cycle, the second signaling based at least in part on the first slot format;
receive, during an OFF duration of the DRX cycle, the second signaling based at least in part on the second slot format; or
transmit, during an OFF duration of the DTX cycle, the second signaling based at least in part on the second slot format.

8. The UE of claim 1, wherein the at least one processor is further operable to cause the UE to:
apply the second slot format for a first duration corresponding to an OFF duration of the DTX cycle and an ON duration of the DRX cycle, wherein the ON duration of the DRX cycle overlaps with the OFF duration of the DTX cycle; and
apply, after the first duration, the first slot format for a second duration corresponding to an ON duration of the DTX cycle and the ON duration of the DRX cycle.

9. The UE of claim 1, wherein the at least one processor is further operable to cause the UE to apply the second slot format to one or more slots associated with an ON duration of a DTX cycle, wherein the one or more slots comprise uplink slots.

10. The UE of claim 1, wherein the at least one processor is further operable to cause the UE to apply at least one of the first slot format or the second slot format a threshold duration after receiving the first signaling, wherein the threshold duration is based at least in part on a current ON duration of at least one of the DTX cycle or the DRX cycle or a subsequent ON duration of at least one of the DTX cycle or the DRX cycle.

11. A method performed by a user equipment (UE), the method comprising:
receiving first signaling that indicates a plurality of slot formats associated with a discontinuous transmission (DTX) cycle and a discontinuous reception (DRX) cycle corresponding to a network equipment (NE), wherein the plurality of slot formats comprises a first slot format associated with an ON duration of at least one of the DTX cycle or the DRX cycle and a second slot format associated with an OFF duration of the at least one of the DTX cycle or the DRX cycle; and
communicating, based at least in part on the ON duration of the at least one of the DTX cycle or the DRX cycle, second signaling based at least in part on the first slot format and the second slot format.

12. A network equipment (NE) for wireless communication, comprising:
at least one memory; and
at least one processor coupled with the at least one memory and operable to cause the NE to:
transmit first signaling that indicates a plurality of slot formats associated with a discontinuous transmission (DTX) cycle and a discontinuous reception (DRX) cycle corresponding to the NE, wherein the plurality of slot formats comprises a first slot format associated with an ON duration of at least one of the DTX cycle or the DRX cycle and a second slot format associated with an OFF duration of the at least one of the DTX cycle or the DRX cycle; and
communicate, based at least in part on the ON duration of the at least one of the DTX cycle or the DRX cycle, second signaling based at least in part on the first slot format and the second slot format.

13. The NE of claim 12, wherein the first signaling comprises one or more downlink control information (DCI) that indicate the first slot format and the second slot format.

14. The NE of claim 13, wherein the one or more DCI comprise a dedicated DCI received during the ON duration of the DTX cycle and a common DCI received prior to an ON duration of the DTX cycle or an ON duration of the DRX cycle.

15. The NE of claim 12, wherein the at least one processor is further operable to cause the NE to transmit radio resource control (RRC) signaling comprising respective pluralities of slot formats associated with a plurality of DTX cycles and DRX cycles, wherein the respective pluralities of slot formats comprise the plurality of slot formats.

16. The NE of claim 12, wherein to communicate the second signaling, the at least one processor is operable to cause the NE to at least one of:
transmit, during an ON duration of the DTX cycle, the second signaling based at least in part on the first slot format;
receive, during an ON duration of the DRX cycle, the second signaling based at least in part on the first slot format;
transmit, during an OFF duration of the DRX cycle, the second signaling based at least in part on the second slot format; or
receive, during an OFF duration of the DTX cycle, the second signaling based at least in part on the second slot format.

17. The NE of claim 12, wherein the at least one processor is further operable to cause the NE to:
apply the second slot format for a first duration corresponding to an OFF duration of the DTX cycle and an ON duration of the DRX cycle, wherein the ON duration of the DRX cycle overlaps with the OFF duration of the DTX cycle; and
apply, after the first duration, the first slot format for a second duration corresponding to an ON duration of the DTX cycle and the ON duration of the DRX cycle.

18. The NE of claim 12, wherein the at least one processor is further operable to cause the NE to apply the second slot format to one or more slots associated with an ON duration of a DTX cycle, wherein the one or more slots comprise uplink slots.

19. The NE of claim 12, wherein the at least one processor is further operable to cause the NE to apply at least one of the first slot format or the second slot format a threshold duration after transmitting the first signaling, wherein the threshold duration is based at least in part on a current ON duration of at least one of the DTX cycle or the DRX cycle or a subsequent ON duration of at least one of the DTX cycle or the DRX cycle.

20. A method performed by a network equipment (NE), the method comprising:
transmitting first signaling that indicates a plurality of slot formats associated with a discontinuous transmission (DTX) cycle and a discontinuous reception (DRX) cycle corresponding to the NE, wherein the plurality of slot formats comprises a first slot format associated with an ON duration of at least one of the DTX cycle or the DRX cycle and a second slot format associated with an OFF duration of the at least one of the DTX cycle or the DRX cycle; and
communicating, based at least in part on the ON duration of the at least one of the DTX cycle or the DRX cycle, second signaling based at least in part on the first slot format and the second slot format.
